(19) United States
(12) Patent Application Publication
(10) Pub. No.: US 2023/0320266 A1
(43) Pub. Date: Oct. 12, 2023

(54) RIDING LAWN MOWER

(71) Applicant: Nanjing Chervon Industry Co., Ltd., Nanjing (CN)

(72) Inventors: Dezhong Yang, Nanjing (CN); Lei Wang, Nanjing (CN); Tonghao Li, Nanjing (CN); Yangzi Liu, Nanjing (CN)

(21) Appl. No.: 18/327,653

(22) Filed: Jun. 1, 2023

Related U.S. Application Data
(63) Continuation of application No. PCT/CN2021/124115, filed on Oct. 15, 2021.

(51) Int. Cl. A01D 34/00; A01D 34/64

(52) U.S. Cl. CPC A01D 34/008; A01D 34/64; A01D 2101/00

(57) ABSTRACT

A riding lawn mower includes: a seat; a chassis; a walking assembly including a left second walking wheel, a right second walking wheel, a left walking motor and a right walking motor; and a walking control system for controlling the left walking motor and the right walking motor. The walking control system includes two current detection modules respectively configured to obtain sampled currents of the left walking motor and the right walking motor; the walking control system is configured to obtain a first feedback current of the left walking motor and a first feedback current of the right walking motor, and when a difference of the first feedback current of the left walking motor and the first feedback current of the right walking motor is greater than or equal to a predefined current threshold, reduce a first target voltage of the walking motor with a higher first feedback current.

### RELATED APPLICATION INFORMATION

This application is a continuation of International Application Number PCT/CN2021/124115, filed on Oct. 15, 2021, which application is incorporated herein by reference in its entirety.

### BACKGROUND

Lawn mowers are widely used in gardening to trim lawn and vegetation. Lawn mowers generally include hand push lawn mowers and riding lawn mowers. A user sits on and drives the riding lawn mower to perform lawn mowing tasks, making lawn mowing more efficient and less tiring. When the riding lawn mower is making a turn, the output torque of the motor to the driving wheels may cause damages to the surf.

### SUMMARY

A riding lawn mower is provided including: a seat for a user to sit thereon; a chassis configured to support the seat; a walking assembly configured to drive the riding lawn mower to walk, the walking assembly includes a walking wheel and a walking motor for driving the walking wheel; a walking motor detection module including a current detection module configured to obtain sampled currents of the walking motor and a speed detection module configured to obtain an actual rotational speed of the walking motor; an operating member operable by the user to generate an operational amount to control the walking assembly; a walking control module configured to drive the walking motor; the walking control module includes: a current transformation unit configured to generate a first feedback current and a second feedback current based on the sampled currents; a conversion unit configured to convert the operational amount into a target rotational speed of the walking motor; a velocity controller configured to compare the actual rotational speed with the target rotational speed and obtain a first target current and a second target current; a first current controller configured to compare the first feedback current with the first target current and obtain a first target voltage; a second current controller configured to compare the second feedback current with the second target current and obtain a second target voltage; a voltage transformation unit configured to generate target voltages applied to the walking motor based on the first target voltage and the second target voltage; and a drive signal generating unit configured to generate drive signals for driving the walking motor based on the target voltage; wherein the walking control module further includes a coefficient adjustment unit that reduces a coefficient of proportionality of the velocity controller when the riding lawn mower is making a turn.

In one example, the riding lawn mower further includes a steering wheel assembly having a steering wheel rotatable about a first axis; the steering wheel has an initial position, a first limit position when rotating clockwise and a second limit position when rotating counterclockwise.

In one example, when the steering wheel is at the initial position, the coefficient of proportionality is a predefined standard value.

In one example, the coefficient adjustment unit starts to reduce the coefficient of proportionality when the steering wheel is rotated from the initial position for more than a first threshold angle.

In one example, the coefficient adjustment unit has a predefined minimum value for the coefficient of proportionality; when the steering wheel is rotated to the first limit position or to the second limit position, the coefficient of proportionality is reduced to the predefined minimum value for the coefficient of proportionality.

In one example, the predefined minimum value for the coefficient of proportionality is greater than or equal to 60% of the predefined standard value.

In one example, the coefficient adjustment unit reduces the coefficient of proportionality linearly with respect to an angle of rotation of steering wheel.

In one example, during the return process of the steering wheel, the coefficient adjustment unit keeps the coefficient of proportionality unchanged until the angle of rotation of steering wheel reaches a second threshold angle.

In one example, the coefficient adjustment unit increases the coefficient of proportionality when the angle of rotation of steering wheel is less than the second threshold angle.

In one example, the second threshold angle is less than the first threshold angle.

A riding lawn mower is provided including: a seat for a user to sit thereon; a chassis configured to support the seat; a walking assembly including at least one first walking wheel and at least two second walking wheels, which are a left second walking wheel and a right second walking wheel, the walking assembly further including a left walking motor for driving the left second walking wheel and a right walking motor for driving the right second walking wheel; and a walking control system configured to control the left walking motor and the right walking motor; wherein the walking control system including two current detection modules respectively configured to obtain sampled currents of the left walking motor and sampled currents of the right walking motor; the walking control system is configured to obtain a first feedback current of the left walking motor from the sampled currents of the left walking motor and obtain a first feedback current of the right walking motor from the sampled currents of the right walking motor, calculate a difference of the first feedback current of the left walking motor and the first feedback current of the right walking motor, and when the difference of the first feedback current of the left walking motor and the first feedback current of the right walking motor is greater than or equal to a predefined current threshold, reduce a first target voltage of the left walking motor when the first feedback current of the left walking motor is higher than the first feedback current of the right walking motor, or reduce a first target voltage of the right walking motor when the first feedback current of the right walking motor is higher than the first feedback current of the left walking motor.

In one example, the first feedback current of the left walking motor is an actual quadrature axis current of the left walking motor, and the first feedback current of the right walking motor is an actual quadrature axis current of the right walking motor.

In one example, the first target voltage of the left walking motor is a target quadrature axis voltage of the left walking motor, and the first target voltage of the right walking motor is a target quadrature axis voltage of the right walking motor.

In one example, the walking control system includes a left walking control module and a right walking control module.

In one example, when the first feedback current of the left walking motor minus the first feedback current of the right walking motor is greater than or equal to the predefined current threshold, the left walking control module reduces the first target voltage of the left walking motor.

In one example, when the first feedback current of the right walking motor minus the first feedback current of the left walking motor is greater than or equal to the predefined current threshold, the right walking control module reduces the first target voltage of the right walking motor.

In one example, the left walking control module includes a current transformation unit configured to obtain the first feedback current of the left walking motor from the sampled currents of the left walking motor.

In one example, the left walking control module includes a first current controller configured to compare the first feedback current with a first target current to obtain the first target voltage.

In one example, the left walking control module includes a coefficient adjustment unit, which reduces the coefficient of proportionality of the first current controller.

In one example, the coefficient of proportionality of the first current controller is reduced linearly with respect to the difference of the first feedback current of the left walking motor and the first feedback current of the right walking motor.

A riding lawn mower is provided including: a seat for a user to sit thereon; a chassis configured to support the seat; a walking assembly configured to drive the riding lawn mower to walk, the walking assembly includes a walking wheel and a walking motor for driving the walking wheel; an operating member operable by the user to generate an operational amount to control the walking assembly; a walking control module configured to drive the walking motor; wherein the walking control module includes: a current controller, a velocity controller, a position controller, and when the operational amount of the operating member is greater than a predefined operational amount threshold, the walking control module is configured to drive the motor in a speed control mode, which uses a current controller and a velocity controller; when the operational amount of the operating member is less than or equal to the predefined operational amount threshold, the walking control module is configured to drive the motor in a position control mode, which uses the current controller and a position controller.

In one example, the operating member has a maximum operational amount, and the predefined operational amount threshold is less than or equal to 10% of the maximum operational amount.

In one example, the operating member is an acceleration pedal, and the operational amount is an angle of rotation of the acceleration pedal.

In one example, the operating member is an operating lever, and the operational amount is an angle of rotation of the operating lever.

In one example, the walking control module includes a conversion unit, in the speed control mode; the conversion unit converts the operational amount into a target rotational speed of the walking motor.

In one example, in the position control mode, the conversion unit converts a change of the operational amount of the operating member into a target position change of a rotor of the walking motor.

In one example, the position controller is connected with a rotor position detection module.

In one example, the velocity controller compares the target rotational speed of the walking motor with an actual rotational speed of the walking motor to obtain a target current of the walking motor.

In one example, the position controller compares the target position change of the rotor of the walking motor with an actual position change of the rotor of the walking motor to obtain a target current of the walking motor.

In one example, the walking motor stops rotating when the actual position change of the rotor reaches the target position change of the rotor.

A riding lawn mower is provided including: a seat for a user to sit thereon; a chassis configured to support the seat; a cutting assembly including a cutting member for mowing, the cutting member being mounted to the chassis; a walking assembly configured to drive the riding lawn mower to walk; a parameter collection unit configured to collect historic records of at least one operating parameter of the riding lawn mower during a working process; a parameter setting unit configured to setup at least one predefined parameter based on the historic records of the at least one operating parameter; a cruise control module configured to control the riding lawn mower in a cruise control mode; wherein when the riding lawn mower enters the cruise control mode, the riding lawn mower operates with the at least one predefined parameter.

In one example, the riding lawn mower further includes a storage device for storing the historic records of the at least one operating parameter.

In one example, the storage device stores the historic records of the at least one operating parameter generated within a predefined time period.

In one example, the parameter setting unit is configured to setup the at least one predefined parameter based on a frequency of occurrence of the historic records of the at least one operating parameter.

In one example, the parameter setting unit is configured to setup the at least one predefined parameter based on an average of the historic records of the at least one operating parameter.

In one example, the parameter setting unit is configured to setup the at least one predefined parameter based on machine learning on the historic records of the at least one operating parameter.

In one example, the at least one operating parameter include a walking speed parameter.

In one example, the parameter setting unit sets a predefined cruising speed in the cruise control mode as a mean or median value of the historic records of the walking speed parameter.

In one example, the at least one operating parameter includes a cutting speed parameter.

In one example, the parameter setting unit sets a predefined cutting speed in the cruise control mode as a mode value of the historic records of the cutting speed parameter.

A riding lawn mower is provided including: a seat for a user to sit thereon; a chassis configured to support the seat; a cutting assembly including a cutting member for mowing, the cutting member being mounted to the chassis; a walking assembly configured to drive the riding lawn mower to walk; a cruise control module configured to control the riding lawn mower to walk at a cruising speed in a cruise control mode; a turning detection unit configured to detect whether the riding lawn mower is making a turn; a control device configured to reduce a walking speed of the riding lawn mower when the riding lawn mower is in the cruise control mode and the turning detection unit determines that the riding lawn mower is making a turn; wherein the control device is respectively connected with the cruise control module and the turning detection unit.

In one example, the control device is configured to restore the walking speed of the riding lawn mower to the cruising speed when the riding lawn mower finishes the turn.

In one example, the riding lawn mower further includes an operating member, the turning detection unit determines that the riding lawn mower is making a turn based on an operational amount of the operating member.

In one example, the riding lawn mower further includes a steering wheel having an initial position, the turning detection unit determines that the riding lawn mower is making a turn when the steering wheel is rotated from the initial position for more than 15 degrees.

In one example, the control device has a safe turning speed, the control device reduces the walking speed of the riding lawn mower to the safe turning speed.

In one example, the riding lawn mower has a plurality of driving modes, and the safe turning speed vary across different driving modes.

In one example, the walking assembly includes a walking motor, the cruise control module controls the walking motor.

In one example, the cruise control module has a velocity controller, which compares a target rotational speed of the walking motor with an actual rotational speed of the walking motor to obtain a target current of the walking motor.

In one example, the control device reduces a coefficient of proportionality of the velocity controller to reduce the walking speed of the riding lawn mower.

In one example, the control device reduces the target rotational speed of the walking motor to reduce the walking speed of the riding lawn mower.

A riding lawn mower is provided including: a seat for a user to sit thereon; a chassis configured to support the seat; a cutting assembly including a cutting member for mowing, the cutting member being mounted to the chassis; a walking assembly configured to drive the riding lawn mower to walk; a cruise control module configured to control the riding lawn mower to walk at a cruising speed in a cruise control mode; a steering wheel assembly including a steering wheel operable by the user; and a speed regulator configured to adjust a cruising speed of the riding lawn mower from a first predefined speed to a second predefined speed when the riding lawn mower is in the cruise control mode; wherein the speed regulator is mounted to the steering wheel assembly.

In one example, the speed regulator is provided on a control panel, the control panel being mounted to the steering wheel assembly.

In one example, the control panel includes a plurality of buttons operable by the user to change the cruising speed.

In one example, the control panel includes a first button for increasing the cruising speed.

In one example, the control panel includes a second button for decreasing the cruising speed.

In one example, the riding lawn mower has a plurality of driving modes, and an acceleration when changing the cruising speed vary across different driving modes.

In one example, the riding lawn mower further includes a display interface for prompting the user with a change of the cruising speed.

In one example, the cruising speed is a predefined value when the riding lawn motor enters the cruise control mode.

In one example, the display interface is integrated with the control panel.

In one example, the first button is operable by the user to change the cruising speed directly to a maximum walking speed allowed in the cruise control mode.

### BRIEF DESCRIPTION OF DRAWINGS

FIG. 1 is a perspective view of a riding lawn mower according to an example of the present application;

FIG. 2 is a perspective view of a riding lawn mower according to another example of the present application;

FIG. 3A is a perspective view of a steering wheel assembly of the riding lawn mower of FIG. 1;

FIG. 3B is another perspective view of a steering wheel assembly of the riding lawn mower of FIG. 1;

FIG. 4 is a circuit diagram of a walking motor of the riding lawn mower of FIG. 1 according to one example;

FIG. 5 is a control system of a walking motor in FIG. 4;

FIG. 6 is a control flow diagram of a coefficient adjustment unit of a walking control module in FIG. 5;

FIG. 7A is a relationship diagram between a coefficient of proportionality and an angle of rotation of a steering wheel when the steering wheel rotates;

FIG. 7B is a relationship diagram between a coefficient of proportionality and time when the steering wheel returns;

FIG. 8A is a walking control system of a left walking motor and a right walking motor according to one example;

FIG. 8B is a walking control system of a left walking motor and a right walking motor according to another example;

FIG. 9 is a control flow diagram of the walking control system of FIG. 8A or FIG. 8B;

FIG. 10 is a control system of a walking motor according to another example;

FIG. 11 is a control flow diagram of a conversion unit of the walking control module in FIG. 10;

FIG. 12 is a front view of a control panel and a display interface according to one example;

FIG. 13 is a control flow of a cruise control mode;

FIG. 14 is a control system of a walking motor in the cruise control mode; and

FIG. 15 is a schematic view of a parameter collecting unit and a parameter setting unit.

### DETAILED DESCRIPTION

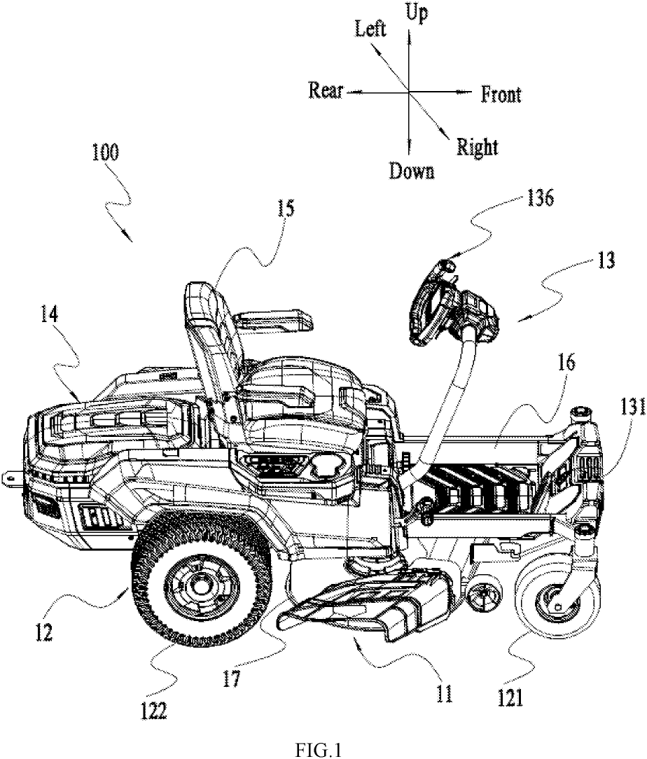

As shown in FIG. 1, a riding lawn mower 100 can be operated by a user sitting on the riding lawn mower 100 to effectively and quickly trim the lawn, vegetation, etc. Comparing with hand push or walk behind lawn mowers, the riding lawn mower 100 of the present disclosure does not require the user to push the machine, nor does it require the user to walk on the ground. Further, because of its large size, the riding lawn mower 100 is able to carry larger or more batteries, which brings a longer working time, so that the user can trim larger lawn areas, and trim for a longer time effortlessly. Furthermore, in terms of energy source, unlike existing riding lawn mowers, the riding lawn mower 100 uses electric energy rather than gasoline or diesel, thus the riding lawn mower 100 is more environmentally friendly, cheaper in usage cost, and less prone to leakage, failure and maintenance.

It is appreciated that aspects of this disclosure are also applicable to riding machines of other types, as long as the riding machine can output power in other forms besides walking power in order to realize other functions besides walking, such as, for example, riding snow blowers, riding agricultural machines, and riding sweepers. In fact, as long as these tools include the substance described below in this disclosure, they all fall within the scope of this disclosure.

Those skilled in the art should understand that, in the disclosure of this application, the terms “controller”, “control unit”, “module”, “unit” and “processor” may include or relate to at least one of hardware or software.

Those skilled in the art should understand that, in the disclosure of this application, the terms “up”, “down”, “front”, “rear”, “left”, “right” and the like indicate the orientation or positional relationship based on the orientation or positional relationship shown in the drawings, which are only for the convenience of describing the present application, and do not indicate or imply that the device or element referred to must have a specific orientation, or be constructed and operated in a specific orientation, and therefore the above terms should not be understood as a limitation of the present application.

Referring to FIG. 1, the riding lawn mower 100 includes: a cutting assembly 11, a walking assembly 12, an operating assembly 13, a power supply assembly 14, a seat 15, a chassis 16, and a deck 17.

The chassis 16 is the main supporting frame of the riding lawn mower 100, and the chassis 16 at least partially extends in a front and rear direction. The seat 15 is configured for a user to sit thereon, and the seat 15 is mounted on the chassis 16. The deck 17 is configured to accommodate the cutting assembly 11, and the deck 17 is installed under the chassis 16.

According to FIG. 1, the direction toward which the user sits on the seat is defined as the front or the front side of the riding lawn mower 100; and the direction opposite to the front is defined as the rear or rear side of the riding lawn mower 100. The user’s left hand direction is defined as the left or left side of the riding lawn mower 100; and the user’s right hand direction is defined as the right or right side of the riding lawn mower 100. The direction toward the ground is defined as the down or lower side of the riding lawn mower 100; and the direction opposite to the down is defined as the up or upper side of the riding lawn mower 100.

The cutting assembly 11 includes a cutting member, such as, for example, a blade, for realizing a cutting function. The cutting assembly 11 is mounted to the chassis 16, under the deck 17. In other words, the deck 17 forms a semi-opening accommodating cavity to accommodate the cutting member. The cutting assembly 11 further includes a cutting motor for driving the cutting member to rotate. The cutting assembly 11 may include more than one cutting members and more than one cutting motors. The cutting motors are controlled by a cutting control module. In some examples, the cutting control module includes a control chip, such as MCU, ARM, and so on.

The walking assembly 12 is configured to enable the riding lawn mower 100 to walk on the ground. The walking assembly 12 may include at least one first walking wheel 121 and at least one second walking wheel 122, for example, two second walking wheels 122, namely a left second walking wheel 122L and a right second walking wheel 122R. The walking assembly 12 may also include at least one walking motor 123 for driving the second walking wheel 122, for example, two walking motors 123, namely a left walking motor 123L and a right walking motor 123R. In this way, when the two walking motors 123 drive the corresponding second walking wheels 122 to rotate at different speeds, a speed difference is generated between the two second walking wheels 122, so as to steer the riding lawn mower 100. The walking motor 123 is controlled by a walking control module 124. In some examples, the walking control module 124 includes a control chip, such as MCU, ARM, and so on. In one example, two walking control modules 124 control the two walking motors 123, respectively. In one example, one central walking control module 124 controls the two walking motors 123.

The power supply assembly 14 is configured to supply electric power to the riding lawn mower 100. The power supply assembly 14 is configured to at least supply electric power to the cutting motor 112 and the walking motor 123. The power supply assembly 14 may also supply electric power to other electronic components in the riding lawn mower 100, such as the cutting control module 113 and the walking control module 124. The power supply assembly 14 may also supply electric power to a lighting assembly 19. In some examples, the power supply assembly 14 is provided on the rear side of the seat 15 on the chassis 16. In some examples, the power supply assembly 14 includes a plurality of battery packs 141 capable of supplying electric power to the riding lawn mower 100.

The operating assembly 13 is operable by the user, and the user sends control instructions through the operating assembly 13 to control the operation of the riding lawn mower 100. The operating assembly 13 can be operated by the user to set the cutting speed, walking speed, walking direction, etc. of the riding lawn mower 100. In other words, the operating assembly 13 can be operated by the user to set an operating status for the riding lawn mower 100, wherein the operating status includes a cutting status and a walking status.

The operating assembly 13 may include at least one switch triggerable to change its state so as to set the riding lawn mower 100 in different status. For example, a seat switch (not shown) arranged under the seat 15 is configured to set the riding lawn mower 100 in a bootable state when the user is sitting on the seat, and set the riding lawn mower 100 in a non-bootable state when no one is sitting on the seat. A start button 133 is configured to start the riding lawn mower 100 when the user presses the start button 133, and stop the riding lawn mower 100 when the user presses the start button 133 again. A key switch 134 is configured to start the walking motor 123 when the user inserts a key and rotates the key to the on position, and stop the walking motor 123 when the user rotates the key to the off position or pulls the key out. A blade actuator 135 is configured to make the cutting member 111 rotate when the user lifts the blade actuator 135 up and stop the cutting member 111 when the user presses the blade actuator 135 down.

The operating assembly 13 also includes an operating member 130 operable by the user to generate an operational amount ω to control the walking assembly. The operating assembly 13 may include a combination of one or more operating mechanisms such as pedal, lever, handle, and steering wheel. The most common types of riding lawn mowers are lap bar mowers and steering wheel mowers. For a steering wheel mower as shown in FIG. 1, a speed control pedal combined with a steering wheel is configured to set up a system for the user to control at least the walking function of the riding lawn mower 100.

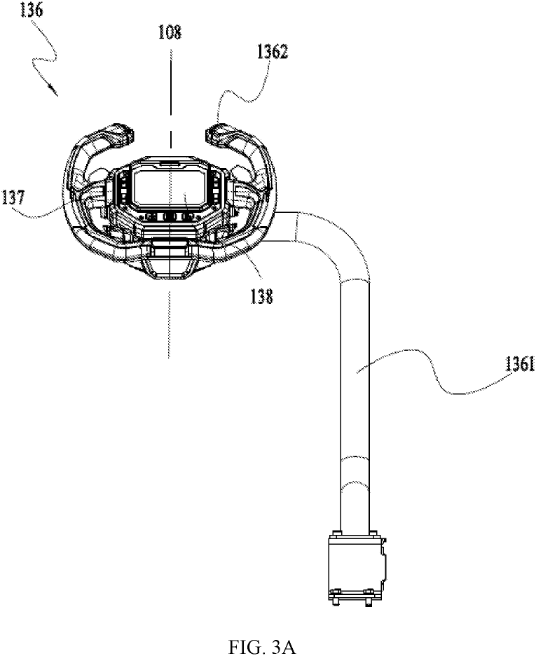

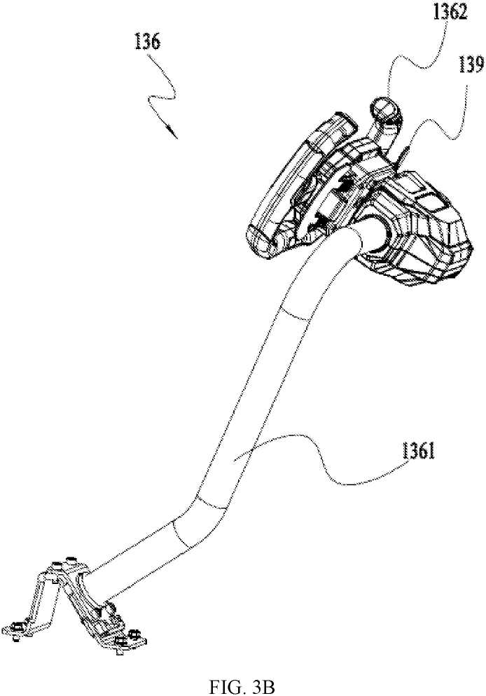

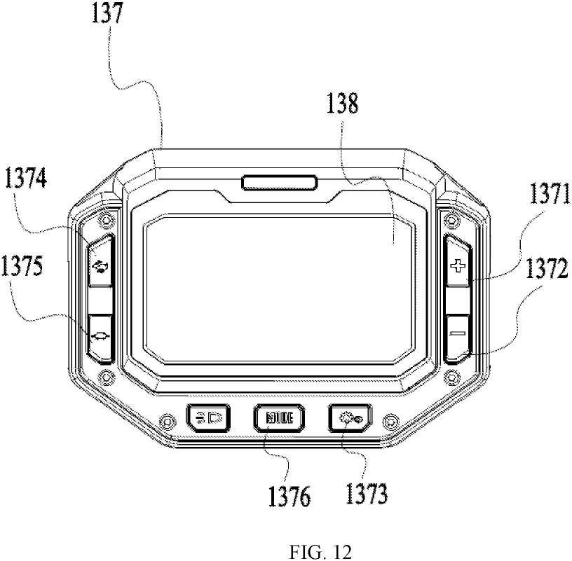

The steering wheel assembly 136 includes a steering wheel 1362 operable to rotate about a first axis 107 and a connecting rod 1361 configured to connect the steering wheel 1362 and the chassis 16. As shown in FIG. 3A, the steering wheel assembly 136 has an initial position, at which the steering wheel 1362 is symmetrical about a second axis 108. From the initial position, the steering wheel 1362 can rotate clockwise about the first axis and reach a first limit position, as shown in FIG. 12A and rotate counterclockwise about the first axis and reach a second limit position, as shown in FIG. 12B. The steering wheel assembly 136 may further include a steering wheel position sensor 1363 to detect the angular position of the steering wheel 1362. The steering wheel position sensor 1363 outputs angular position signals of the steering wheel 1362 to the walking control module 124, wherein the angular positions may be represented in degree values.

In one example, the speed control pedal is an acceleration pedal 131. The user steps on a pedal lever of the acceleration pedal 131 to control the walking speed of the riding lawn mower 100. A pedal position sensor 132 detects the angular position of the pedal lever and outputs angular position signals of the pedal lever to the walking control module 124, wherein the angular positions may be represented in degree values. The walking control module 124 calculates the target rotational speed of the walking motor 123 from the position signals of the acceleration pedal 131 and the steering wheel assembly 136, so as to control the riding lawn mower 100 to reach a desired walking speed.

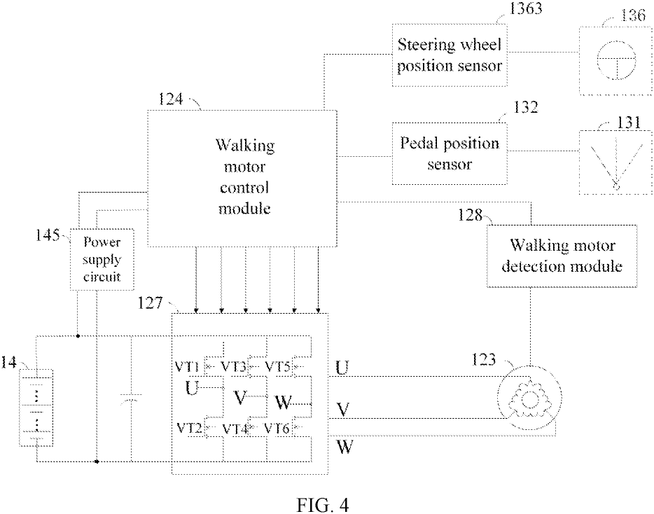

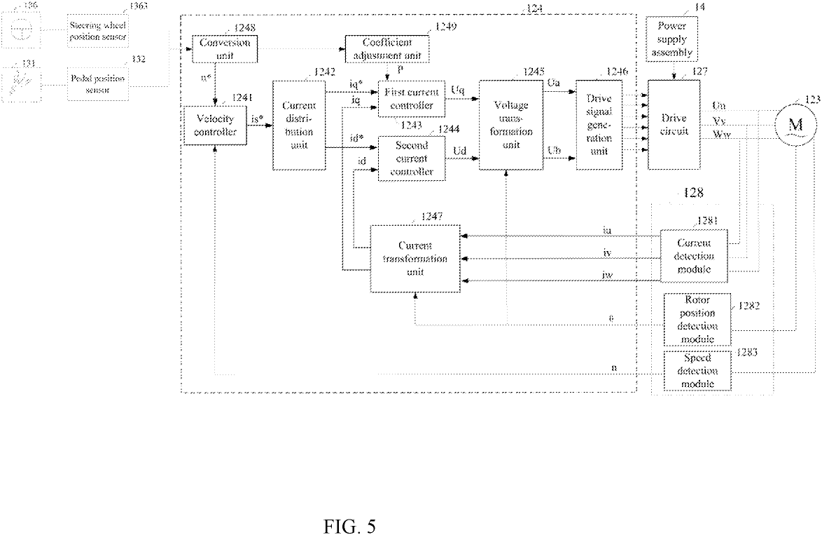

Referring to FIGS. 4 and 5, in one example, besides the walking control module 124, the steering wheel assembly 136 and the acceleration pedal 131, the control system for the walking motor 123 further includes: a drive circuit 127, a power supply circuit 145, and a walking motor detection module 128. Since the control systems of the left and the right walking motors 123 have the same or similar functions and components, the control system described in this example is applicable to the control system of the left and the right walking motors 123. In other words, the walking control module 124 described in this example may be a left walking control module 124L configured to control the left walking motor 123L, or a right walking control module 124R configured to control the right walking motor 123R.

In some examples, the walking control module 124 may be a dedicated controller, such as a dedicated control chip (for example, MCU, Microcontroller Unit). The power supply circuit 145 is connected to the power supply assembly 14, and the power supply circuit 145 is configured to receive the power from the power supply assembly 14 and convert the power of the power supply assembly 14 into the power at least used by the walking control module 124. The power supply assembly 14 includes a plurality of aforementioned battery packs 141. The drive circuit 127 is electrically connected to the walking control module 124 and the walking motor 123, and controls the operation of the walking motor 123 according to the drive signal output by the walking control module 124. In one example, the walking motor 123 is a three-phase brushless motor with three-phase windings, and the drive circuit 127 is a three phase bridge inverter, which includes semiconductor switches VT1, VT2, VT3, VT4, VT5, and VT6. The semiconductor switches VT1-VT6 may be field effect transistors, IGBT transistors, etc. The gate terminal of each switch is electrically connected with the walking control module 124, and the drain or source of each switch is electrically connected with the winding of the walking motor 123.

The walking motor detection module 128 is coupled to the walking motor 123, and is configured to detect operational parameters of the walking motor 123, for example, such as, the rotor position, the actual rotational speed, and the phase currents of the walking motor 123. In one example, the walking motor detection module 128 includes a speed detection sensor, which is arranged near or inside the walking motor 123 to obtain the actual rotational speed of the walking motor 123; for example, a Hall sensor arranged near the rotor of the walking motor 123 to obtain the rotor position and the actual rotational speed of the walking motor 123. In one example, if the walking motor 123 is a brushless motor, the electrical signal output by the walking motor 123 is a periodically changed back electromotive force; thus, by detecting the voltage of the walking motor 123 and spotting the zero-crossing point of the back electromotive force, the actual rotational speed of the walking motor 123 can be obtained. In one example, the position of the rotor 1231 can also be estimated from the phase currents of the walking motor 123, a current detector may be provided between the walking motor 123 and the walking control module 124.

In one example, the walking control module 124 is configured to output corresponding drive signals to the drive circuit 127 based on the target rotational speed of the walking motor 123, the actual rotational speed of the walking motor 123, the actual current of the walking motor 123 and the position of the rotor 1231 of the walking motor 123, thereby changing at least one of the voltage or current applied to the windings of the walking motor 123, so as to generate an alternating magnetic field to drive the walking motor 123.

More details of the control method adopted by the walking control module 124 will be described with reference to FIG. 5. Specifically, the walking control module 124 includes: a conversion unit 1248, a coefficient adjustment unit 1249, a velocity controller 1241, a current distribution unit 1242, a first current controller 1243, a second current controller 1244, a voltage transformation unit 1245, a current transformation unit 1247 and a drive signal generation unit 1246. The walking motor detection module 128 includes: a current detection module 1281, a rotor position detection module 1282, and a speed detection module 1283. These modules are introduced for the sake of clear description; in implementation, one operational parameter may be calculated from another, for example, the rotational speed of the motor can be deducted from information about the rotor position, therefore, these modules can be combined.

In one example, the pedal position sensor 132 is coupled with the acceleration pedal 131, and the steering wheel position sensor 1363 is couple with the steering wheel 1362. The pedal position sensor 132 and the steering wheel position sensor 1363 send position signals of the acceleration pedal 131 and the steering wheel assembly 136 to the conversion unit 1248. The conversion unit 1248 is configured to convert the operational amount into a target rotational speed n* of the walking motor 123. Specifically, the conversion unit 1248 is configured to receive position signals of the acceleration pedal 131 and the steering assembly 136 and outputs the target rotational speed n* of the walking motor 123. In one example, a mapping function from the position signals of the acceleration pedal 131 and the steering assembly 136 to the target rotational speed n* of the walking motor 123 is stored in the conversion unit 1248. In one example, the position signals of the acceleration pedal 131 is mapped to a basic speed value and then the position signals of the steering wheel assembly 136 is applied to adjust the basic speed value to produce the target rotational speed n* of the walking motor 123.

The velocity controller 1241 is connected with the conversion unit 1248 and the speed detection module 1283. The velocity controller 1241 obtains the target rotational speed n* of the walking motor 123 from the conversion unit 1248 and the actual rotational speed n of the walking motor 123 detected by the speed detection module 1283. The velocity controller 1241 is configured to generate a target current is* according to the target rotational speed n* and the actual rotational speed n through comparison and adjustment. The resulted target current is* is configured to make the actual rotational speed n approach the target rotational speed n*. In one example, the velocity controller 1241 adopts a Proportional Integral (PI) controller. As the name suggests, the PI controller includes a proportional term and an integral term. In one example, the proportional term is the error between the target rotational speed n* and the actual rotational speed n multiplied by a coefficient of proportionality P. Increasing the proportional gain has the effect of proportionally increasing the control signal for the same level of error, however, the fact that the controller will “push” harder for a given level of error tends to cause the closed-loop system to react more quickly, but also to overshoot more. Further, it is safer and more comfortable to reduce the rotational speed of the walking motor when the riding lawn mower is making a turn. Therefore, in this example, the coefficient of proportionality P, which is also sometimes referred to as the torque coefficient, is reduced when the riding lawn mower is making a turn. The coefficient adjustment unit 1249 is configured to reduce the coefficient of proportionality P during a turn and restore the coefficient of proportionality P when the turn is finished.

In one example, the coefficient adjustment unit 1249 is coupled with the steering wheel position sensor 1363, and the steering wheel position sensor 1363 sends position signals of the steering wheel assembly 136 to the coefficient adjustment unit 1249. In another example, the conversion unit 1248 passes the position or angle of rotation of the steering wheel assembly 136 to the coefficient adjustment unit 1249. When the steering wheel 1362 is at the initial position, the coefficient of proportionality P is a predefined standard value. In some examples, the riding lawn mower provides the user with a selection of driving modes. The user may switch between the driving modes through a mode button 1376. The predefined standard value may vary across different driving modes. For example, the predefined standard value of the coefficient of proportionality P in a sport mode is the greatest; the predefined standard value of the coefficient of proportionality P in a control mode is the least; the predefined standard value of the coefficient of proportionality P in a standard mode is less than that in the sport mode and greater than that in the control mode.

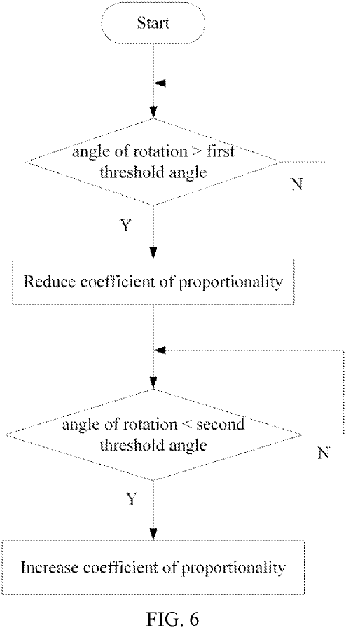

The control flow of the coefficient adjustment unit 1249 is shown in FIG. 6. When the user wants to make a turn, the user rotates the steering wheel 1362, and the coefficient adjustment unit 1249 starts to reduce the coefficient of proportionality P when the steering wheel 1362 is rotated from the initial position for more than a first threshold angle. In one example, the coefficient adjustment unit 1249 starts to reduce the coefficient of proportionality P when the steering wheel 1362 is rotated from the initial position for more than 15 degrees; in one example, the coefficient adjustment unit 1249 starts to reduce the coefficient of proportionality P when the steering wheel 1362 is rotated from the initial position for more than 20 degrees; in one example, the coefficient adjustment unit 1249 starts to reduce the coefficient of proportionality P when the steering wheel 1362 is rotated from the initial position for more than 25 degrees.

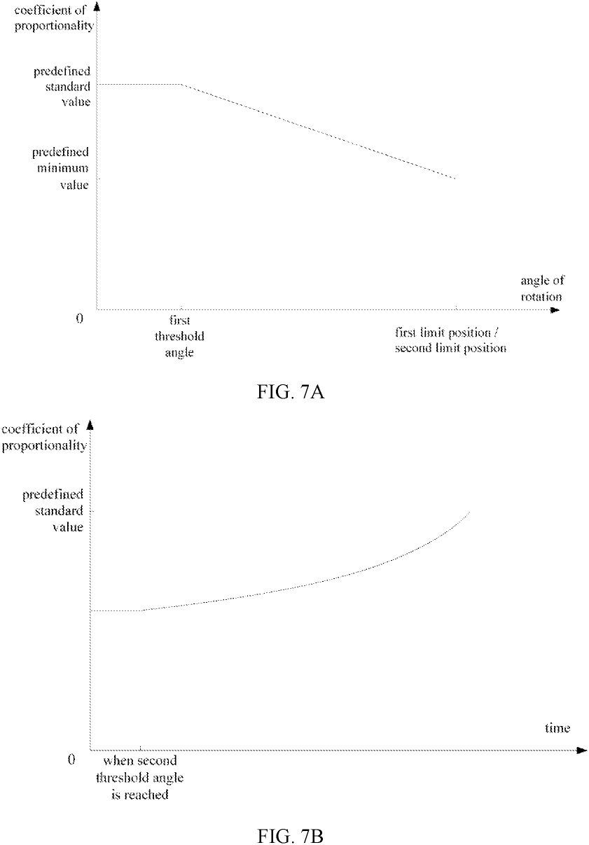

The coefficient adjustment unit 1249 has a predefined minimum value for the coefficient of proportionality P. When the steering wheel 1362 is rotated to the first limit position or to the second limit position, the coefficient of proportionality P is reduced to the predefined minimum value for the coefficient of proportionality P. It should be understood that, the coefficient of proportionality P may also be reduced to the predefined minimum value before the steering wheel reaches the first limit position or to the second limit position. In one example, the predefined minimum value for the coefficient of proportionality P is greater than or equal to 55% of the predefined standard value. In one example, the predefined minimum value for the coefficient of proportionality P is greater than or equal to 60% of the predefined standard value. In one example, the predefined minimum value for the coefficient of proportionality P is greater than or equal to 65% of the predefined standard value. In one example, as shown in FIG. 7A, the coefficient adjustment unit 1249 reduces the coefficient of proportionality P linearly with respect to the angle of rotation of steering wheel, until the predefined minimum value is reached or the steering wheel starts to return.

During the return process of the steering wheel, the coefficient adjustment unit 1249 keeps the coefficient of proportionality P unchanged until the angle of rotation of steering wheel reaches a second threshold angle. When the angle of rotation of steering wheel is less than the second threshold angle, the coefficient adjustment unit 1249 increases the coefficient of proportionality P. The second threshold angle is less than the first threshold angle. For example, the second threshold angle is 10 degrees or 15 degrees. In one example, the coefficient adjustment unit 1249 increases the coefficient of proportionality P linearly with respect to time. In one example, as shown in FIG. 7B, the coefficient adjustment unit 1249 increases the coefficient of proportionality P exponentially with respect to time. For example, the coefficient adjustment unit 1249 increases the coefficient of proportionality P 0.03% per 500 us.

The current distribution unit 1242 is connected to the velocity controller 1241, and is configured to distribute a target direct axis current id* and a target quadrature axis current iq* based on the target current is*. The target quadrature axis current iq* and the target direct axis current id* can be obtained by calculation, or can be set directly, for example, id* may be set to 0. The target direct axis current id* and the target quadrature axis current iq* distributed by the current distribution unit 1242 according to the target current is* can cause the rotor of the walking motor 123 to generate different electromagnetic torque Te, so that the walking motor 123 can reach the target rotational speed n* of the walking motor 123 through different accelerations.

The current transformation unit 1247 obtains sampled currents from the current detection module 1281 and generates a first feedback current and a second feedback current. In one example, the current transformation unit 1247 obtains the three-phase currents iu, iv, and iw of the walking motor 123 and performs current transformation to convert the three-phase currents iu, iv, and iw into two-phase currents: the actual quadrature axis current iq and the actual direct axis current id, wherein the first feedback current is the actual quadrature axis current iq, and the second feedback current is the actual direct axis current id. The current transformation unit 1247 includes Park transformation and Clark transformation.

The first current controller 1243 obtains the target quadrature axis current iq* from the current distribution unit 1242 and the actual quadrature axis current iq from the current transformation unit 1247, and generates a first target voltage Uq. The first target voltage Ud can make the actual quadrature axis current iq approach the target quadrature axis current iq* as soon as possible. The first current controller 1243 includes a comparison and adjustment unit (not shown), the adjustment unit may be PI adjustment, and the first current controller 1243 includes comparing the target quadrature axis current iq* and the actual quadrature axis current iq, and performing the PI adjustment according to the comparison result to generate the first target voltage Uq.

The second current controller 1244 obtains the target direct axis current id* from the current distribution unit 1242 and the actual direct axis current id from the current transformation unit 1247, and generates a second target voltage Uq. The second target voltage Ud can make the actual direct axis current id approach the target direct axis current id*. The second current controller 1244 includes a comparison and adjustment unit (not shown), the adjustment unit may be PI adjustment, and the second current controller 1244 includes comparing the target direct axis current id* and the actual direct axis current id, and performing the PI adjustment according to the comparison result to generate the second target voltage Ud.

The voltage transformation unit 1245 obtains the first target voltage Uq and the second target voltage Ud from the first current controller 1243 and the second current controller 1244 respectively, as well as the position of the rotor of the walking motor 123 from the rotor position detection module 1282, and converts the first target voltage Uq and the second target voltage Ud into intermediate voltage adjustment amounts Ua and Ub related to the three-phase voltage Uu, Uv, Uw applied to the walking motor 123, and output them to the drive signal generation unit 1246. Optionally, the voltage transformation unit 1245 includes inverse Park transformation.

The drive signal generation unit 1246 generates drive signals such as PWM signals for controlling the switching elements of the drive circuit 127 according to the intermediate voltage adjustment amounts Ua and Ub, so that the power supply assembly 14 can output three-phase voltages Uu, Uv, Uw to be applied to the windings of the walking motor 123. Optionally, the drive signal generation unit 1246 adopts the SVPWM technique. In one example, Uu, Uv, Uw are three-phase symmetrical sine wave voltages or saddle wave voltages, and the three-phase voltages Uu, Uv, Uw form a 120° phase difference with each other.

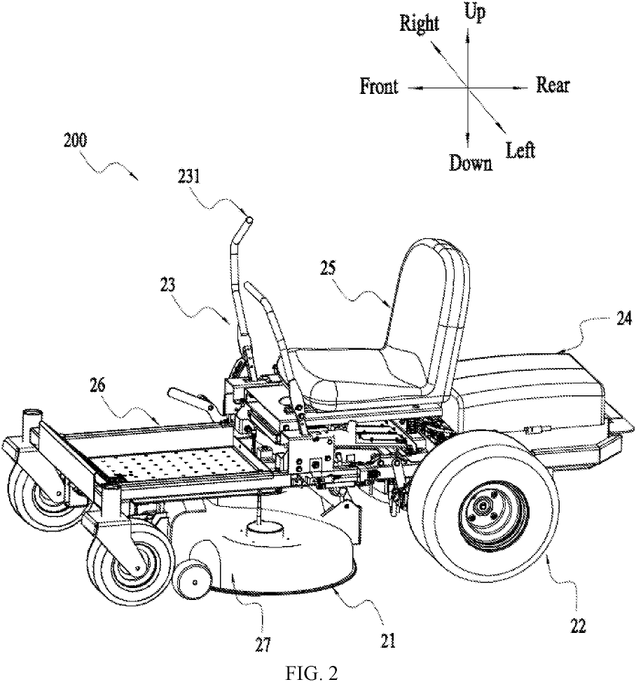

In other examples, the riding lawn mower does not include a steering wheel, instead, the riding lawn mower is provided with other operating member or operating members operable by the user to generate certain operational amounts to control the walking direction of the riding lawn mower. In one example, referring to FIG. 2, the riding lawn mower 200 is a lap bar mower. The riding lawn mower 200 in FIG. 2 includes: a cutting assembly 21, a walking assembly 22, an operating assembly 23, a power supply assembly 24, a seat 25, a chassis 26, and a deck 27. The operating assembly 23 includes a pair of operating levers 231 operable by the user to control the walking direction as well as the walking speed of the riding lawn mower 200.

In this case, the coefficient adjustment unit 1249 adjusts the coefficient of proportionality P of the velocity controller based on a difference of the operational amounts of the operating levers 231. For example, the coefficient adjustment unit 1249 reduces the coefficient of proportionality P of the velocity controller when the difference of the operational amounts of operating levers 231 is greater than or equal to a certain threshold. In yet another example, the operational amounts from the operating members are not used in the adjustment process to reducing the output torque of the walking motor when the riding lawn mower is making a turn.

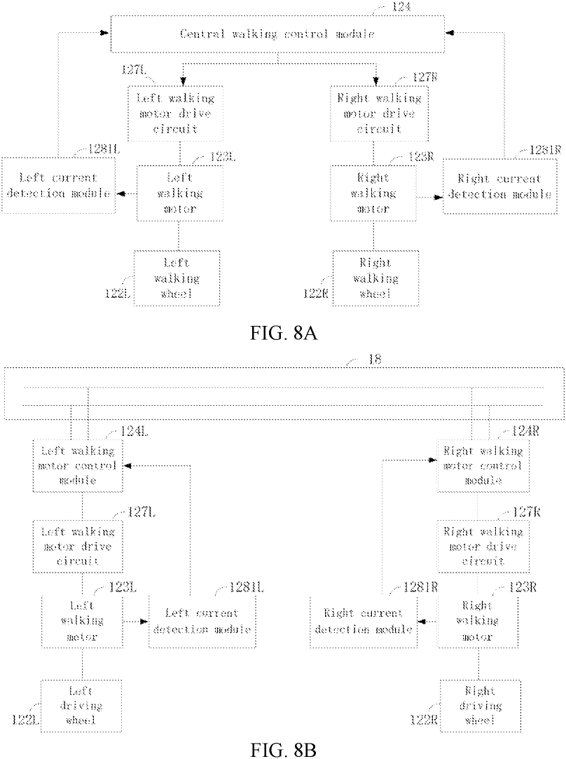

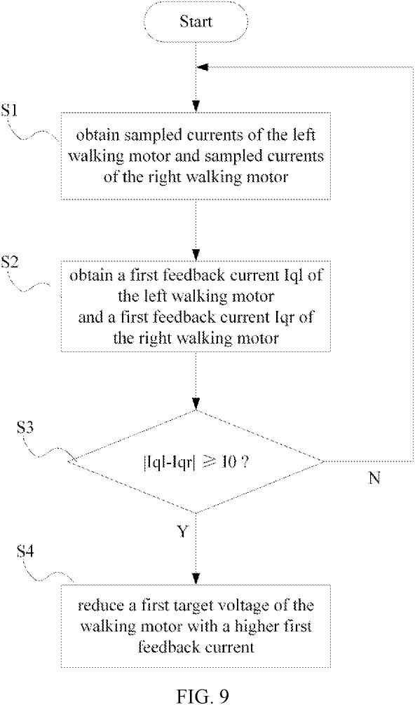

In one example, a walking control system is configured to control the left walking motor 123L and the right walking motor 123R. In a centralized implementation manner, referring to FIG. 8a, the walking control system includes a central walking control module 124 for controlling the left walking motor 132L and the right walking motor 123R. In a distributed implementation manner, referring to FIG. 8b, the walking control system includes a left walking control module 124L for controlling the left walking motor 123L and a right walking control module 124R for controlling the right walking motor 123R. Data transmission is realized through a bus module 18. Most of the control flow of the left walking control module and the right walking control module is basically the same as the walking control module in FIG. 5. Referring to the FIG. 9, the walking control system reduces the output torque of the walking motor during a turn in the following steps:

At step S1, the walking control system is configured to obtain the sampled currents of the left walking motor 123L and the sampled currents of the right walking motor 123R. In one example, the walking control system has two current detection modules 1281, namely a left current detection module 1281L and a right current detection module 1281R, which respectively obtains the sampled currents of the left walking motor 123L and the right walking motor 123R.

At step S2, the walking control system is configured to obtain a first feedback current Iql of the left walking motor 123L from the sampled currents of the left walking motor 123L and a first feedback current Iqr of the right walking motor 123R from the sampled currents of the right walking motor 123R.

At step S3, the walking control system calculates a difference between the first feedback current Iql of the left walking motor 123L and the first feedback current Iqr of the right walking motor 123R, and determines whether the difference between the first feedback current Iql of the left walking motor 123L and the first feedback current Iqr of the right walking motor 123R is greater than or equal to a predefined current threshold I0; if yes, go to step S4, otherwise go back to step S1.

At step S4, the walking control system reduces a first target voltage of the walking motor 123 with a higher first feedback current. That is, if the first feedback current Iql of the left walking motor 123L is higher than the first feedback current Iqr of the right walking motor 123R, the walking control system reduces the first target voltage of the left walking motor 123L; if the first feedback current Iqr of the right walking motor 123R is higher than the first feedback current Iql of the left walking motor 123L, the walking control system reduces the first target voltage of the right walking motor 123R.

In the example of the distributed implementation, the left walking control module 124L and the right walking control module 124R each carries out steps S1 through S4 iteratively. At step S1, the left current detection module 1281L obtains and sends the sampled three-phase currents iu, iv, and iw of the left walking motor 123L to the left walking control module 124L. The right current detection module 1281R obtains and sends the sampled the three-phase currents iu, iv, and iw of the right walking motor 123R to the right walking control module 124R.

At step S2, the left walking control module 124L obtains the first feedback current Iql of the left walking motor 123L through its current transformation unit 1247L and sends the first feedback current Iql of the left walking motor 123L to the bus module 18. The first feedback current Iql of the left walking motor 123L is the actual quadrature axis current iq of the left walking motor 123L. Similarly, the right walking control module 124R obtains the first feedback current Iqr of the right walking motor 123R through its current transformation unit 1247R and sends the first feedback current Iqr of the right walking motor 123R to the bus module 18. The first feedback current Iqr of the right walking motor 123R is the actual quadrature axis current iq of the right walking motor 123R.

At step S3, the left walking control module 124L and the right walking control module 124R each carries out the computation and comparison to decide whether to proceed to step S4. The left walking control module 124L determines if the first feedback current Iql of the left walking motor 123L minus the first feedback current Iqr of the right walking motor 123R is greater than or equal to the predefined current threshold I0; if yes, go to step S4, otherwise go back to step S1. The right walking control module 124R determines if the first feedback current Iqr of the right walking motor 123R minus the first feedback current Iql of the left walking motor 123L is greater than or equal to the predefined current threshold I0; if yes, go to step S4, otherwise go back to step S1.

At step S4, the left walking control module 124L reduces the first target voltage of the left walking motor 123L. For example, the left walking control module 124L includes the first current controller 1243L, which obtains the target quadrature axis current iq* from the current distribution unit 1242L and the actual quadrature axis current iq from the current transformation unit 1247L, and generates the first target voltage. The first target voltage of the left walking motor 123L is a target quadrature axis voltage Uq* of the left walking motor 123L. The left walking control module 124L further includes the coefficient adjustment unit 1249L, which reduces the coefficient of proportionality P of the first current controller 1243L at this step. In one example, the coefficient of proportionality P of the first current controller 1243 is reduced linearly with respect to the difference of the first feedback current Iql of the left walking motor 123L and the first feedback current Iqr of the right walking motor 123R. The right walking control module 124R reduces the first target voltage of the right walking motor 123R with the same method described above. The first target voltage of the right walking motor 123R is a target quadrature axis voltage Uq* of the right walking motor 132R. In this way, when the riding lawn mower 100 is making a turn, the output torque of the walking motor 124 driving the second walking wheel 122 gets reduced, thereby protecting the turf from damages.

In the aforementioned examples, through the velocity controller 1241, a speed loop forms the outer loop of the walking control module 124; and through the current controllers, i.e., the first current controller 1243 and the second current controller 1244, a current loop forms the inner loop of the walking control module 124. However, at low speed, or when the operational amount ω of the operating member 130, such as an operating lever 231, an acceleration pedal 131, is little, the speed signal may become inaccurate and vulnerable to jitters.

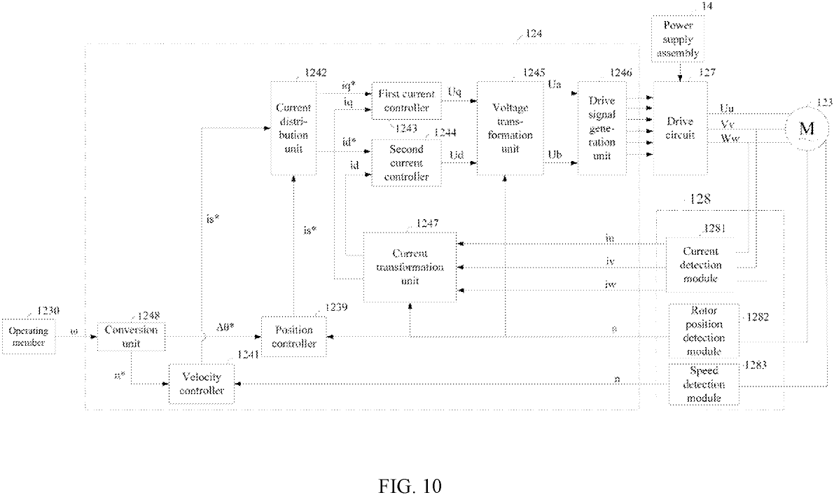

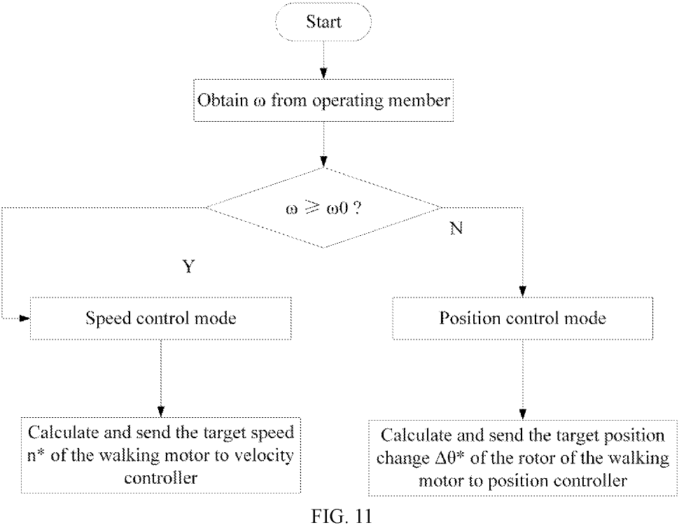

In one example, referring to FIG. 10, to make the low speed control smoother, besides the current controllers and the velocity controller 1241, the walking control module 124 further includes a position controller 1239, and through the position controller 1239, a position loop replaces the speed loop to be the outer loop of the walking control module 124. The switching of the position loop and the speed loop depends on the operational amount ω of the operating member 130. When the operational amount ω of the operating member 130 is greater than a predefined operational amount threshold ω0, the walking control module 124 is configured to drive the motor in a speed control mode, which uses the current controllers and the velocity controller 1241; when the operational amount ω of the operating member 130 is less than or equal to the predefined operational amount threshold ω0, the walking control module 124 is configured to drive the motor in a position control mode, which uses the current controllers and the position controller 1239.

In one example, the operating member 130 has a maximum operational amount ωₘₐₓ, and the predefined operational amount threshold ω0 is less than or equal to 10% of the maximum operational amount ωₘₐₓ; alternatively, the predefined operational amount threshold ω0 is less than or equal to 5% of the maximum operational amount ωₘₐₓ. In one construction, the operating member 130 is an acceleration pedal 131, and the operational amount ω is an angle of rotation of the acceleration pedal 131. The maximum operational amount ωₘₐₓ of the acceleration pedal 131 is 60 degrees, and the predefined operational amount threshold ω0 maybe 6 degrees, 5 degrees, or 2 degrees. In another construction, the operating member 130 is an operating lever 231, and the operational amount ω is an angle of rotation of the operating lever 231. The maximum operational amount ωₘₐₓ of the operating lever 231 is 120 degrees, and the predefined operational amount threshold ω0 maybe 12 degrees, 10 degrees, or 8 degrees.

The functionality of the conversion unit 1248 is altered to accommodate the two control modes. In the speed control mode, the conversion unit 1248 converts the operational amount ω of the operating member 130 into a target rotational speed n* of the walking motor 123. For example, when the acceleration pedal 131 is pressed by the user for 30 degrees, which is within the range of the speed control mode, then the conversion unit 1248 outputs a target rotational speed n* of, for example, 3000 rpm to the velocity controller. The velocity controller 1241 compares the target rotational speed n* of the walking motor 123 with an actual rotational speed n of the walking motor to obtain a target current is* of the walking motor 123. The actual rotational speed n of the walking motor may be obtained from the speed detection module 1283.

In the position control mode, the conversion unit 1248 converts a change, or displacement, of the operational amount Δω of the operating member 130 into a target position change of the walking motor 123, wherein the target position change of the walking motor is a target position change Δθ* of the rotor of the walking motor 123. In other words, in the position control mode, the position change Δω of the operating member 130 is transferred into the position change Δθ* of the rotor of the walking motor 123. For example, when the acceleration pedal 131 is pressed by the user for only 2 degrees, which is within the range of the position control mode, then the conversion unit computes the difference between the operational amount ω of the acceleration pedal 131 this time and the operational amount ω of the acceleration pedal 131 last time and outputs a target position change Δθ* of the rotor of, for example, ½ rounds to the position controller 1239. Herein, ½ rounds means to rotate ½ rounds from the current position of the rotor, 3 rounds means to rotate 3 rounds from the current position of the rotor, and so on. The position controller 1239 compares the target position change Δθ* of the rotor of the walking motor with an actual position change Δθ of the rotor of the walking motor to obtain a target current is* of the walking motor 123. The actual position change Δθ of the rotor of the walking motor 123 may be obtained from the rotor position detection module 1282. Alternatively, the actual position θ of the rotor of the walking motor 123 is obtained from the rotor position detection module 1282, and the position controller 1239 calculates the actual position change Δθ based on the actual position θ obtained throughout the time.

The position controller 1239 is connected with the conversion unit 1248 and the rotor position detection module 1282. The position controller 1239 obtains the target position change Δθ* of the rotor of the walking motor 123 from the conversion unit 1248 and the actual position change Δθ of the rotor of the walking motor 123 from the rotor position detection module 1282. The position controller 1239 is configured to generate a target current is* according to the target position change Δθ* of the rotor and the actual position change Δθ of the rotor through comparison and adjustment. The resulted target current is* is configured to make the actual position change Δθ of the rotor approach the target position change Δθ* of the rotor. In one example, the position controller 1239 adopts a Proportional Integral (PI) controller. As the name suggests, the PI controller includes a proportional term and an integral term. In one example, the proportional term is the error between the target position change Δθ* of the rotor and the actual position change Δθ of the rotor of the walking motor 123 multiplied by a coefficient of proportionality P. The walking motor 123 stops rotating when the actual position change Δθ of the rotor reaches the target position change Δθ* of the rotor.

In one example, based on the input of the operational amount ω of the operating member 130, the conversion unit 1248 both determines the control mode and converts the input into an output. Specifically, referring to FIG. 11, when the operational amount ω of the operating member 130 is greater than the predefined operational amount threshold ω0, the conversion unit 1248 sets the control mode as the speed control mode, calculates and sends the target rotational speed n* of the walking motor 123 to the velocity controller 1241; when the operational amount ω of the operating member 130 is less than or equal to the predefined operational amount threshold ω0, the conversion unit 1248 sets the control mode as the position control mode, calculates and sends the target position change Δθ* of the rotor of the walking motor to the position controller 1239.

The riding lawn mower 100 further provides the user with a cruise control mode. In one example, as shown in FIG. 3B, the operating assembly 13 further includes at least one paddle shifter 139 operable by the user to send a command to enter the cruise control mode. Specifically, the riding lawn mower 100 may be equipped with a pair of paddle shifters 139, respectively a left paddle shifter 139L and a right paddle shifter 139R. In one construction, the paddle shifters 139 are mounted to the steering wheel 1362. As shown in FIGS. 3 and 12, the operating assembly 13 may also include a control panel 137. The control panel 137 may include a plurality of buttons, which issue different commands when pressed; for example, a “+” button 1371 sends a command to increase the cutting speed of the cutting member; a “-” button 1372 sends a command to decrease the cutting speed of the cutting member. The operating assembly 13 may also include a display interface 138, which displays the operating status of the riding lawn mower 100, for example, the parameters during a cruise control process. In one example, the display interface 138 is mounted in the center of the control panel 137; the control panel 137 is mounted in the center of the steering wheel 1362. In one construction, the display interface 138 and the control panel 137 are integrated together and then mounted to the steering wheel assembly 136. In one example, the left paddle shifter 139L and the right paddle shifter 139R are mounted to the casing of the control panel 137 or the display interface 138. The left paddle shifter 139L extends to the left side of the riding lawn mower 100, the right paddle shifter 139R extends to the right side of the riding lawn mower 100, so that when the user holds the steering wheel 1362 with both hands, the left paddle shifter 139L is triggerable by at least one finger of a left hand and the right paddle shifter 139R is triggerable by at least one finger of a right hand. When operating the paddle shifters 139, the user’s hands don’t need to leave the steering wheel 1362; therefore operations to the paddle shifters 139 are handy when the user is driving the riding lawn mower 100.

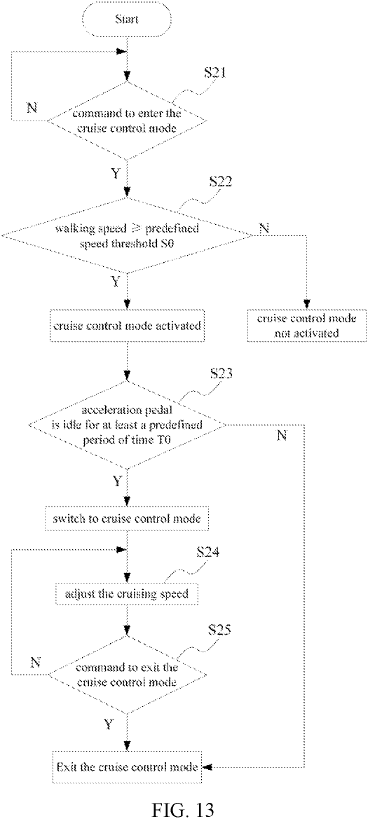

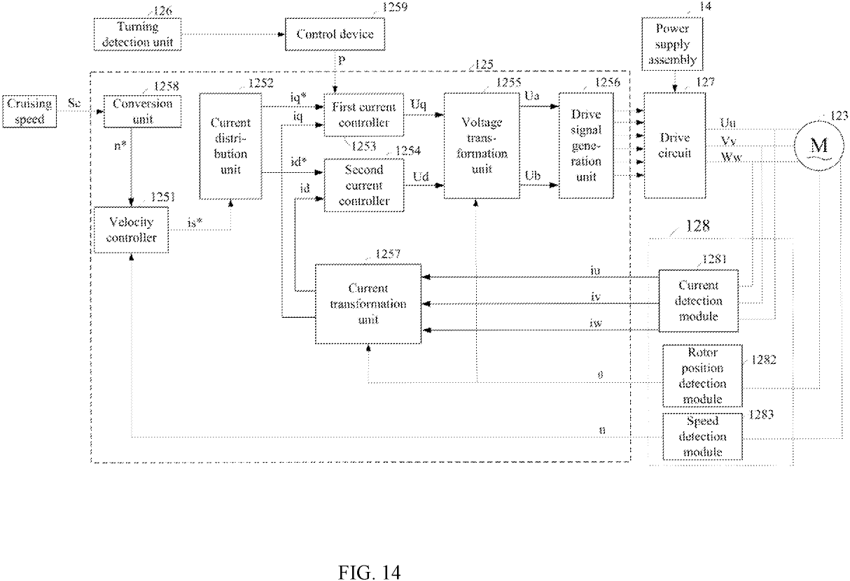

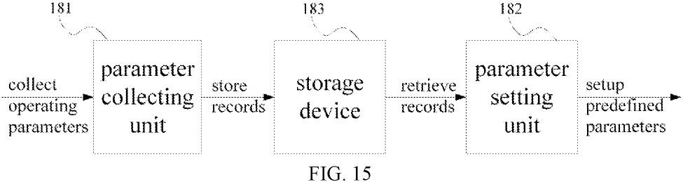

The riding lawn mower 100 includes a cruise control module 125 configured to control the riding lawn mower 100 to walk at a cruising speed Sc in a cruise control mode, so that the user can remove the foot from the acceleration pedal 131. The control flow of the cruise control module 125 is described with reference to FIG. 13. At step S21, the user sends a command to enter the cruise control mode. In one example, the user operates the at least one paddle shifter 139 to send a command to enter the cruise control mode. For example, a command to enter the cruise control mode is issued when both paddle shifters 139 are pressed substantially at the same time for a minimum time period, such as 0.5 seconds. In another example, the user operates the control panel 137 to send a command to enter the cruise control mode. For example, a command to enter the cruise control mode is issued when a “cruise” button of the control panel 137 is pressed. For another example, a command to enter the cruise control mode is generated when a “settings” button 1373 of the control panel 137 is long pressed.

However, the command to enter the cruise control mode does not necessarily trigger the cruise control mode. The cruise control module 125 of the riding lawn mower 100 checks other conditions before switching into the cruise control mode. At step S22, in one example, the walking speed of the riding lawn mower 100 is compared with a predefined speed threshold S0, if the walking speed of the riding lawn mower 100 is greater than or equal to the predefined speed threshold S0, the cruise control mode is activated; otherwise the cruise control mode is not activated. In one example, the predefined speed threshold S0 is 2 km/h; in one example, the predefined speed threshold S0 is 2.5 km/h; in one example, the predefined speed threshold S0 is 3 km/h. When the cruise control mode is not activated, the display interface 138 gives a prompt indicating that the riding lawn mower 100 fails to activate the cruise control mode due to the speed limitation. The lighting assembly 19 may also emit flashing light to alarm the user. The riding lawn mower 100 may also be equipped with a beeper or buzzer (not shown) to send an auditory prompt. When the cruise control mode is activated, the display interface 138 also gives a prompt or displays a “cruise” icon indicating that the cruise control mode is successfully activated. The beeper or buzzer may send a different auditory prompt indicating the successful activation of the cruise control mode. In one example, the cruising speed Sc is a predefined value when the riding lawn mower enters the cruise control mode. The predefined value of the cruising speed Sc may vary across different driving modes. In one example, the predefined value of the cruising speed Sc of the control mode is 5 km/h; the predefined value of the cruising speed Sc of the standard mode is 6 km/h; the predefined value of the cruising speed Sc of the sport mode is 7 km/h. In another example, the current angular position of the acceleration pedal 131 is recorded. The walking speed corresponding to this angular position of the acceleration pedal 131 is recorded as the cruising speed Sc when the riding lawn mower enters the cruise control mode.

At step S23, in one example, after the cruise control mode is successfully activated, the cruise control module 125 switches to the cruise control mode if the acceleration pedal 131 is idle for at least a predefined period of time T0, that is, the user does not press the acceleration pedal 131 for at least the predefined period of time T0; otherwise the cruise control module 125 exit the cruise control mode. In one example, the predefined period of time T0 is 2 seconds. In one example, the predefined period of time T0 is 3 seconds. In one example, the predefined period of time T0 is 4 seconds. In one example, the riding lawn mower 100 adjusts its walking speed to the cruising speed Sc before switching to the cruise control mode. In the cruise control mode, the cruise control module 125 controls the riding lawn mower 100 to walk at the cruising speed Sc.

At step S24, in one example, the user may adjust the cruising speed Sc if needed. The riding lawn mower 100 is provided with a speed regulator operable by the user to adjust the cruising speed Sc from a first speed to a second speed during the cruise control process. In one example, the speed regulator is mounted to the steering wheel assembly 136. In one example, the speed regulator is provided on the control panel 137. In one example, the control panel 137 includes a plurality of buttons operable by the user to change the cruising speed Sc, for example, such as, a first button 1374 increases the cruising speed Sc of the cruise control mode when pressed, in one construction, the first button 1374 has a “rabbit” icon or shape; and a second button 1375 decreases the cruising speed Sc of the cruise control mode when pressed, in one construction, the second button 1375 has a “tortoise” icon or shape. The amount of acceleration or deceleration when the first button 1374 or the second button 1375 is pressed may vary across different driving modes. In one example, the acceleration and deceleration of the control mode is 0.12 km/h; the acceleration and deceleration of the standard mode is 0.19 km/h; the acceleration and deceleration of the sport mode is 0.35 km/h. At the same time, the display interface 138 may prompt the user with the change of the cruising speed Sc. In one example, the current cruising speed Sc is displayed by the display interface 138, for example, next to the “cruise” icon. In one example, long press the first button changes the cruising speed Sc of the cruise control mode directly to a maximum walking speed allowed in the cruise control mode. In implementation, in the cruise control mode, the conversion unit obtains the target rotational speed of the walking motor 123 from the cruising speed Sc, thus, when the user operates the speed regulator to change the cruising speed Sc, the target rotational speed of the walking motor 123 output by the conversion unit reflect these changes accordingly, so as to control the second walking wheel.

At step 25, when the paddle shifters 139 are pressed again, or when the acceleration pedal 131 is pressed, or when a braking applied, the cruise control module 125 exits the cruise control mode. The acceleration pedal 131 restores the control of the walking speed of the riding lawn mower 100. The display interface 138 also gives a prompt indicating the exit of the cruise control mode, or removes the icon of the cruise control mode. The beeper or buzzer may also send an auditory prompt indicating the exit of the cruise control mode.

In one example, the riding lawn mower 100 includes a turning detection unit 126 configured to detect whether the riding lawn mower 100 is making a turn. As described above, the turning detection unit 126 may determine whether the riding lawn mower 100 is making a turn based on the operational amount ω of the operational member 130. For example, the turning detection unit 126 decides that the riding lawn mower 100 is making a turn when the steering wheel 1362 is rotated from the initial position for more than a first turning threshold, for example, 10 degrees, or 15 degrees.

The riding lawn mower 100 further includes a control device 1259 respectively connected with the cruise control module 125 and the turning detection unit 126. The control device 1259 is configured to reduce the walking speed of the riding lawn mower 100 when the riding lawn mower 100 is in the cruise control mode and the turning detection unit 126 determines that the riding lawn mower 100 is making a turn. In one example, the control device 1259 has a safe turning speed. When the riding lawn mower 100 has a plurality of driving modes, the safe turning speed may vary across different driving modes. In one example, the safe turning speed of the control mode is 3 km/h; the safe turning speed of the standard mode is 4 km/h; the safe turning speed of the sport mode is 5 km/h. In one example, the control device 1259 reduces the walking speed of the cruise control mode from the cruising speed Sc to the safe turning speed. In implementation, as shown in FIG. 13, the cruise control module 125 controls the walking motor 123, through a similar manner as the walking control module described above, except that the target rotational speed n* of the walking motor 123 is derived based on the cruising speed Sc instead of the operational amount ω of the operating member 130. Specifically, the cruise control module 125 has a velocity controller 1251, which compares the target rotational speed n* of the walking motor 123 with the actual rotational speed n of the walking motor 123 to obtain a target current is* of the walking motor 123. To reduce the walking speed of the riding lawn mower 100, the control device 1259 reduces a coefficient of proportionality P of the velocity controller 1251 when the riding lawn mower 100 is making a turn. Alternatively, the control device 1259 reduces the target rotational speed of the walking motor 123 to meet the safe turning speed.

In one example, the control device 1259 is configured to restore the walking speed of the riding lawn mower 100 to the cruising speed Sc when the riding lawn mower 100 finishes the turn. The turning detection unit 126 may determine whether the riding lawn mower 100 finishes the turn based on the operational amounts of the operational members. For example, the turning detection unit 126 decides that the riding lawn mower 100 finishes the turn when the steering wheel 1362 is rotated from the initial position for no more than a second turning threshold, for example, 5 degrees, or 3 degrees. It is noted that, during a turn, the control device 1259 reduces and restores the walking speed of the cruise control module 125, while the riding lawn mower 100 remains in the cruise control mode.

In one example, the riding lawn mower 100 includes a parameter collecting unit 181 configured to collect historic records of at least one operating parameter of the riding lawn mower 100 during a working process and a parameter setting unit 182 configured to setup at least one predefined parameter based on the historic records of the at least one operating parameter. When the riding lawn mower 100 enters the cruise control mode, the riding lawn mower 100 operates with the at least one predefined parameter.

In one example, the riding lawn mower 100 further includes a storage device 183 for storing the historic records of the at least one operating parameter. The storage device 183 may be a Random Access Memory (RAM), a flash memory and so on. The storage device 183 is connected with the parameter collecting unit 181 and the parameter setting unit 182. The parameter collecting unit 181 stores the collected records on the storage device 183. The parameter setting unit 182 retrieves the records from the storage device 183 and performs data analysis on the records to assign proper values for the at least one predefined parameter.

It is understood that, on the storage device 183, the space arranged to store historic records of the at least one operating parameter is limited. The storage device 183 may also be used for other purposes, so only a partition of the storage device is designated to store historic records of the at least one operating parameter. When the specified memory partition is used up, old records are overwritten by new records. The scrolling storage method keeps the latest records and saves the storage space. In another example, the storage device stores the historic records of the at least one operating parameter generated within a predefined time period, for example, 30 days, 60 days, one year and so on. The length of the predefined time period may also be set by the user, for example, through the control panel 137. Historic records with a timestamp beyond the predefined time period are removed from the storage device 183 regularly, or whenever the riding lawn mower 100 is powered on. Generally, recent historic records are more valuable than old historic records in determining the user’s current habit and preferences in operating the riding lawn mower 100. The advantages of keeping only recent historic records are saving the storage space, plus simplifying the data set for parameter setting unit 182.

In one example, the parameter setting unit 182 is configured to setup the at least one predefined parameter based on a frequency of occurrence of the historic records of the at least one operating parameter. For example, the at least one operating parameter includes a cutting speed parameter. During a working process, the user can adjust the cutting speed of the cutting member with the ″+” button 1371 and the “-” button 1372 on the control panel 137. The values of the cutting speed are stored in the storage device 183, and the parameter setting unit 182 sets a predefined cutting speed in the cruise control mode to be the mode value of the historic records of the cutting speed parameter.

In another example, the parameter setting unit 182 is configured to setup the at least one predefined parameter based on an average of the historic records of the at least one operating parameters. For example, the at least one operating parameter includes a walking speed parameter. During a working process, the user can press the acceleration pedal 131 to adjust the walking speed of the riding lawn mower 100. The values of the walking speed of the lawn mower, or the values of the angular position of the acceleration pedal 131 are stored in the storage device, and the parameter setting unit 182 sets a predefined cruising speed Sc in the cruise control mode to be the mean or median value of the historic records of the walking speed parameter, that is, the mean or median value of the historic records of the walking speed of the lawn mower, or the walking speed corresponding to the mean or median value of the historic records of the angular position of the acceleration pedal 131.

In yet another example, the parameter setting unit 182 is configured to setup the at least one predefined parameter based on machine learning on the historic records of the at least one operating parameter. Specifically, some of the historic records are used as training data to construct a model, and some of the historic records are used as testing data to verify the model. Then the model is used to generate the at least one predefined parameter.

Aspects of this disclosure are also applicable to riding machines of other types, as long as the riding machine can output power in other forms besides walking power in order to realize other functions besides walking. The above described examples, of course, are not to be construed as limiting the breadth of the present invention. Modifications, and other alternative constructions, will be apparent which are within the spirit and scope of the invention as defined in the appended claims.

What is claimed is:

1. A riding lawn mower, comprising:
a seat for a user to sit on;
a chassis configured to support the seat;
a cutting assembly for mowing;
a walking assembly configured to drive the riding lawn mower to walk;
a cruise control module configured to control the riding lawn mower to walk at a cruising speed in a cruise control mode;
a turning detection unit configured to detect whether the riding lawn mower is making a turn; and
a control device configured to reduce a walking speed of the riding lawn mower when the riding lawn mower is in the cruise control mode and the turning detection unit determines that the riding lawn mower is making a turn;
wherein the control device is respectively connected with the cruise control module and the turning detection unit.

2. The riding lawn mower of claim 1, wherein the control device is configured to restore the walking speed of the riding lawn mower to the cruising speed when the riding lawn mower finishes the turn.

3. The riding lawn mower of claim 1, further comprising an operating member, wherein the turning detection unit determines that the riding lawn mower is making a turn based on an operational amount of the operating member.

4. The riding lawn mower of claim 1, further comprising a steering wheel having an initial position, wherein the turning detection unit determines that the riding lawn mower is making a turn when the steering wheel is rotated from the initial position for more than 15 degrees.

5. The riding lawn mower of claim 1, wherein the control device has a safe turning speed and the control device reduces the walking speed of the riding lawn mower to the safe turning speed.

6. The riding lawn mower of claim 5, wherein the riding lawn mower has a plurality of driving modes and the safe turning speed vary across different driving modes.

7. The riding lawn mower of claim 1, wherein the walking assembly comprises a walking motor and the cruise control module controls the walking motor.

8. The riding lawn mower of claim 7, wherein the cruise control module has a velocity controller that compares a target rotational speed of the walking motor with an actual rotational speed of the walking motor to obtain a target current of the walking motor.

9. The riding lawn mower of claim 8, wherein the control device reduces a coefficient of proportionality of the velocity controller to reduce the walking speed of the riding lawn mower.

10. The riding lawn mower of claim 8, wherein the control device reduces the target rotational speed of the walking motor to reduce the walking speed of the riding lawn mower.

11. The riding lawn mower of claim 1, further comprising a speed regulator configured to adjust the cruising speed of the riding lawn mower from a first speed to a second speed when the riding lawn mower is in the cruise control mode.

12. The riding lawn mower of claim 11, wherein the speed regulator is provided on a control panel and the control panel comprises a plurality of buttons operable by the user to change the cruising speed.

13. The riding lawn mower of claim 12, wherein the control panel comprises a first button for increasing the cruising speed.

14. The riding lawn mower of claim 12, wherein the control panel comprises a second button for decreasing the cruising speed.

15. The riding lawn mower of claim 13, wherein the first button is operable by the user to change the cruising speed directly to a maximum walking speed allowed in the cruise control mode.

16. A riding lawn mower, comprising:
a seat for a user to sit on;
a chassis configured to support the seat;
a cutting assembly for mowing;
a walking assembly configured to drive the riding lawn mower to walk;
a cruise control module configured to control the riding lawn mower to walk at a cruising speed in a cruise control mode; and
a speed regulator configured to adjust a cruising speed of the riding lawn mower from a first speed to a second speed when the riding lawn mower is in the cruise control mode.

17. The riding lawn mower of claim 16, further comprising a steering wheel assembly comprising a steering wheel operable by the user, wherein the speed regulator is mounted to the steering wheel assembly.

18. The riding lawn mower of claim 16, wherein the speed regulator is provided on a control panel, the control panel is mounted to the steering wheel assembly, and the control panel comprises a plurality of buttons operable by the user to change the cruising speed.

19. The riding lawn mower of claim 18, wherein the control panel comprises a first button for increasing the cruising speed.

20. The riding lawn mower of claim 18, wherein the control panel comprises a second button for decreasing the cruising speed.
